(19) United States
(12) Patent Application Publication
(10) Pub. No.: US 2026/0267571 A1
(43) Pub. Date: Sep. 10, 2026

(54) PRINT ERROR DIAGNOSIS

(71) Applicant: Rose Nemeth, Boulder, CO (US)

(72) Inventor: Rose Nemeth, Boulder, CO (US)

(73) Assignee: Ricoh Company, Ltd., Tokyo (JP)

(21) Appl. No.: 19/074,408

(22) Filed: Mar. 9, 2025

(51) Int. Cl. G06F 3/12

(52) U.S. Cl. CPC G06F 3/121; G06F 3/1234

(57) ABSTRACT

System, method, and software for diagnosing errors in printing. In an embodiment, a print error diagnosis manager is configured to receive a print error file comprising information regarding an error in printing a print job at a print system, determine a configuration of the print system, select a test set of print diagnosis devices from a pool of the print diagnosis devices to run a diagnostic test on the print error file based on the configuration of the print system, construct a private local network comprised of the test set of the print diagnosis devices, instruct the test set of the print diagnosis devices in the private local network to perform the diagnostic test on the print job, receive diagnostic test results from performing the diagnostic test, and analyze the diagnostic test results.

### TECHNICAL FIELD

The following disclosure relates to the field of image formation, and in particular, to troubleshooting print errors.

### BACKGROUND

Image formation is a procedure whereby one or more digital images are recreated by applying a marking material (e.g., ink, toner, etc.) to a printable medium, such as paper. Image forming apparatuses are used as printers, facsimile machines, copiers, plotters, multi-functional devices or multifunction peripherals (MFPs), etc. Errors may occur in image formation (also referred to generally as printing), such as at an image forming apparatus that receives a job, at a host device that submits a job, at a server (e.g., print server) that queues, manages, and/or schedules jobs, etc. Some errors may be solved on-site by maintenance personnel or the like, while others may not. Thus, it is beneficial for an entity, such as a printer manufacturer, to offer technical support services that are able to diagnose the cause of errors.

### SUMMARY

Embodiments described herein provide an automated technical support service for print systems or other types of image formation systems. In general, the technical support service accepts a print error file(s) regarding an error encountered at a print system performing a printing process for a print job. The technical support service attempts to recreate or reproduce at least part of the print environment employed when encountering the error. To do so, the technical support service dynamically constructs a private local network (e.g., at a test center or laboratory) comprising one or more print diagnosis devices that emulate the print system of a print operator, and runs one or more diagnostic tests on a print job within the private local network. The technical support service may also analyze diagnostic test results, report the diagnostic test results to the print operator, provide a recommendation to resolve any errors to the print operator, and/or other functions. One technical benefit is the technical support service provides an effective and secure way of resolving issues encountered at a print system, particularly the types of issues that cannot be effectively addressed on-site.

In an embodiment (also referred to as aspects), an apparatus comprises a print error diagnosis manager comprising at least one processor and memory. The at least one processor is configured to cause the print error diagnosis manager at least to receive a print error file comprising information regarding an error in printing a print job at a print system, determine a configuration of the print system, and select a test set of print diagnosis devices from a pool of the print diagnosis devices to run a diagnostic test on the print error file based on the configuration of the print system, wherein the test set of the print diagnosis devices includes at least one on-premises print-related machine. The at least one processor is further configured to cause the print error diagnosis manager at least to construct a private local network comprised of the test set of the print diagnosis devices, instruct the test set of the print diagnosis devices in the private local network to perform the diagnostic test on the print job, receive diagnostic test results from performing the diagnostic test, and analyze the diagnostic test results by performing a comparison of elements of the diagnostic test results to corresponding elements of the print error file to identify differences.

Other embodiments may include computer readable media, other systems, or other methods as described below.

The above summary provides a basic understanding of some aspects of the specification. This summary is not an extensive overview of the specification. It is intended to neither identify key or critical elements of the specification nor delineate any scope of particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments of the present disclosure are now described, by way of example only, and with reference to the accompanying drawings. The same reference number represents the same element or the same type of element on all drawings.

FIGS. 1A-1C are diagrams of print systems in illustrative embodiments.

FIG. 2 is a schematic diagram of an image forming apparatus in an illustrative embodiment.

FIG. 3 is a block diagram of a print operation in an illustrative embodiment.

FIG. 4 is a block diagram of a diagnosis system in an illustrative embodiment.

FIGS. 5A-5F are flow charts illustrating a method of providing technical support in illustrative embodiments.

FIG. 6 is a block diagram of a diagnosis system in an illustrative embodiment.

FIG. 7 is a block diagram of a diagnosis system in an illustrative embodiment.

FIG. 8 is a block diagram illustrating analysis of diagnostic test results in an illustrative embodiment.

FIG. 9 is a block diagram illustrating analysis of diagnostic test results in an illustrative embodiment.

FIG. 10 is a block diagram illustrating reporting of a diagnosis report in an illustrative embodiment.

FIG. 11 is a block diagram illustrating self-monitoring within a diagnosis system in an illustrative embodiment.

FIG. 12 is a block diagram illustrating a print error diagnosis manager receiving one or more print error files in an illustrative embodiment.

FIG. 13 is a flow chart illustrating additional steps of the method in FIG. 5A in an illustrative embodiment.

FIG. 14 is a block diagram illustrating a private local network in an illustrative embodiment.

FIG. 15 shows a test printer in an illustrative embodiment.

FIG. 16 is a flow chart illustrating a method of monitoring a print diagnosis device in an illustrative embodiment.

FIG. 17 illustrates a processing system operable to execute a computer readable medium embodying programmed instructions to perform desired functions in an illustrative embodiment.

### DETAILED DESCRIPTION

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

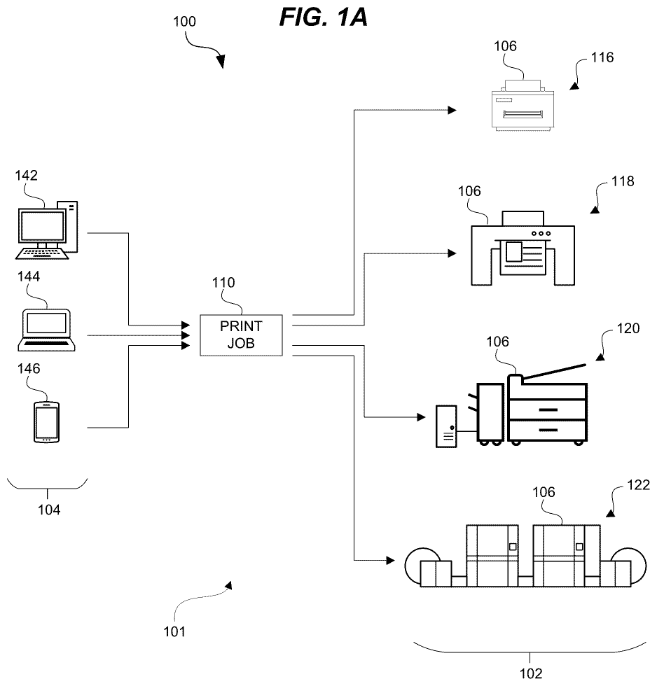

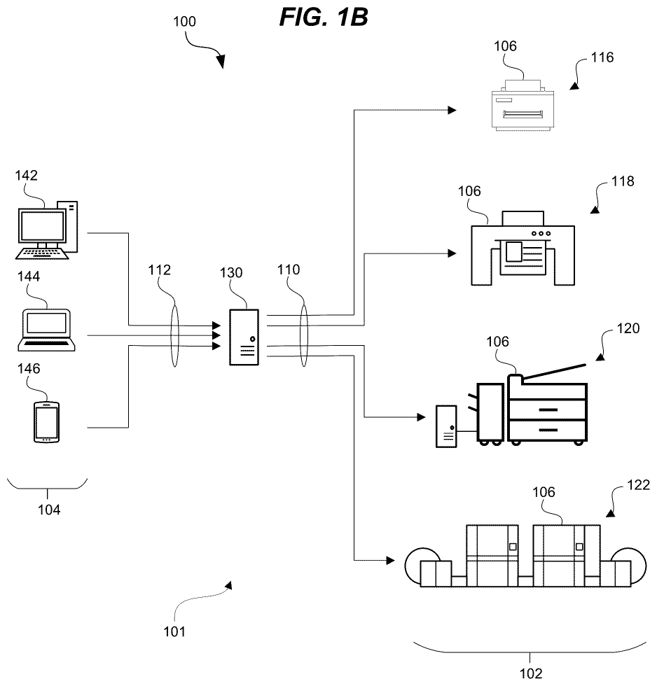

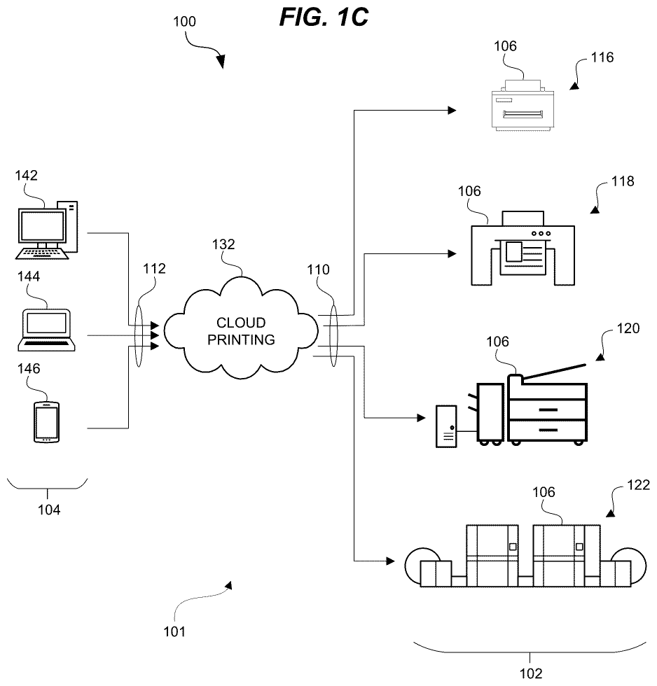

FIGS. 1A-1C are diagrams of print systems 100 in illustrative embodiments. A print system 100 in general comprises one or more print devices 101 (also referred to as print-related devices, print equipment, print apparatuses, etc.) that produce printed material based on one or more print jobs 110. In an embodiment, a print system 100 may comprise one or more image forming apparatuses 102 and one or more host devices 104. An image forming apparatus 102 (also referred to as a printer 106 herein) may comprise an apparatus that performs image formation (printing) on a recording or printable medium by applying colorants or marking/recording material on the basis of print data. A printer 106 may comprise an MFP 116, a wide-format printer 118, a cut-sheet printer 120, a continuous-form printer 122 that prints on a web of continuous-form media, etc. A printer 106 as described herein, such as cut-sheet printer 120 and/or continuous-form printer 122, may comprise a production type of printer configured to print at speeds of hundreds of pages or more per minute. A host device 104 (also referred to as a host terminal, a client device, etc.) is an information processing apparatus or end user device that submits print files for printing. For example, a host device 104 may comprise a personal computer (PC) 142, a laptop 144, a mobile device 146, or another type of device that runs or executes a software program or application configured to submit a job for printing. The submission of a host device 104 may comprise a print job 110 as illustrated in FIG. 1A. A print job 110 is a unit of work to be run on a printer 106 or on another type of image forming apparatus 102 or print device 101. A print job 110 may comprise one or more print files, may comprise job information such as a job ticket containing instructions to process and print a job, etc.

FIG. 1B illustrates another type of print system 100. In this embodiment, print system 100 further comprises a print server 130. The print server 130 (also referred to as a management server) is a server apparatus that communicatively couples a host device 104 to one or more printers 106. The print server 130 may be configured to manage print requests 112 from a host device 104, generate print jobs 110 based on data received in the print requests 112, submit print jobs 110 to one or more printers 106, etc. For example, a print request 112 from a host device 104 may comprise one or more print files or documents, instructions for printing of the print files, etc.

FIG. 1C illustrates another type of print system 100. In this embodiment, print system 100 further comprises a cloud printing service 132 implemented on a cloud computing platform. Cloud-computing allows users access to a variety of services over an internet connection. Some examples of a cloud computing platform may comprise Amazon Web Services (AWS), Google Cloud, Microsoft Azure, etc. Cloud printing service 132 communicatively couples a host device 104 to one or more printers 106 or other on-premises equipment. The cloud printing service 132 is configured to manage print requests 112 from a host device 104, generate print jobs 110 based on data received in the print requests 112, submit print jobs 110 to one or more printers 106, etc.

FIGS. 1A-1C illustrate examples of print systems 100 that may be implemented by a print operator, although other types of print systems are considered herein. Although not specifically shown, one or more devices of a print system 100 may be configured to perform data communication with one another via a communication network. The communication network may comprise, for example, a network including a local area network (LAN), a wide area network (WAN), such as the Internet, etc., and may comprise a wired network, a wireless network, or a network including both of a wired network and a wireless network. A print system 100 may be configured for professional, commercial, production, or industrial printing. Commercial printing may be performed by Print Service Providers (PSP) or other providers that offer printing services to users/customers in exchange for monetary compensation. For example, a PSP may offer printing services for advertising or marketing materials, product manuals, books, invoices/bills, blueprints, mailings, etc. A PSP may own or operate a variety of printing equipment, referred to generally as a print shop. For example, a print shop may include one or more printers 106 and/or other print equipment (e.g., post-print devices, finishing devices, etc.).

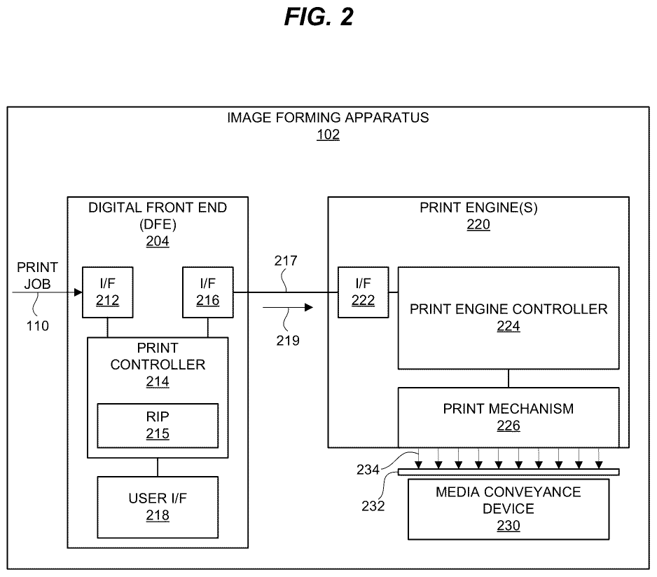

FIG. 2 is a schematic diagram of an image forming apparatus 102 in an illustrative embodiment. Image forming apparatus 102 is a type of device that executes an image forming process (e.g., printing process) on a recording or printable medium. In an embodiment, image forming apparatus 102 includes a Digital Front End (DFE) 204, and one or more print engines 220. DFE 204 is an information processing apparatus configured to accept a print job 110, and convert the print job 110 into a suitable format for a print engine(s) 220. More particularly, DFE 204 generates print data 219 by a raster image processor (RIP) engine on the basis of the print job 110, and transmits the print data 219 to the print engine(s) 220. In an embodiment, DFE 204 may be on-ground or on-premises with the print engine(s) 220. In general, “on-premises” means that the infrastructure exists on-site in contrast to being hosted off-site. DFE 204 may be implemented on a separate (on-premises) platform from the print engine(s) 220, or may be integrated on a platform of the print engine(s) 220. In an embodiment, DFE 204 may communicate with the print engine(s) 220 over a communication network.

In an embodiment, DFE 204 includes an Input/Output (I/O) interface 212, a print controller 214, and a print engine interface 216, and may also include a user interface 218 (also referred to as an operator console). I/O interface 212 comprises an apparatus, device, circuitry, means, and/or other component configured to receive a print job 110 from a source, such as a host device 104, a print server 130, a cloud printing service 132, etc. I/O interface 212 may be considered a network interface in some embodiments. The print job 110 comprises one or more print files (also referred to as job files or vector files) formatted with a Page Description Language (PDL), such as PostScript, Printer Command Language (PCL), Intelligent Printer Data Stream (IPDS), etc. The print job 110 may also comprise a job ticket containing instructions, requirements, and/or other control information for processing and/or printing a print job, such as a Job Definition Format (JDF) job ticket. Print controller 214 comprises an apparatus, device, circuitry, means, and/or other component configured to transform the print job 110 into print data 219 comprising one or more digital images (also referred to as raster images or halftone images) that may be used by print engine 220 to mark a printable medium 232 with ink, toner, or another recording or marking material. In an embodiment, print controller 214 includes a Raster Image Processor (RIP) 215 that translates or rasterizes the print job 110 to generate digital images or raster images that a printer can understand and print. A digital or raster image comprises a two-dimensional array of pixels or dots, also referred to as a bitmap (e.g., halftone bitmap). Whereas the print file(s) of the print job 110 in PDL format is a high-level description of the content (e.g., text, graphics, pictures, etc.), a digital image defines a pixel value or color value for each pixel in a display space. Print engine interface 216 comprises an apparatus, device, circuitry, means, and/or other component configured to communicate with a print engine(s) 220, such as to transmit digital images to the print engine(s) 220. Print engine interface 216 may be communicatively coupled to a print engine(s) 220 via one or more communication links 217 (e.g., a fiber link, a bus, a communication cable, etc.), and is configured to transfer the digital images to the print engine(s) 220. User interface 218 is a component configured to interact with a human operator. A human operator may access user interface 218 to view status indicators or updates, view or manipulate settings, schedule print jobs, etc.

Print engine 220 includes a DFE interface 222, a print engine controller 224, and a print mechanism 226 (or multiple print mechanisms). DFE interface 222 comprises an apparatus, device, circuitry, means, and/or other component configured to interact with DFE 204, such as to receive print data 219 from DFE 204. Print engine controller 224 comprises an apparatus, device, circuitry, means, and/or other component configured to process the print data 219 (e.g., the digital or raster images) received from DFE 204, and provide control signals to print mechanism 226. Print mechanism 226 is an image formation device (or devices) that marks the printable medium 232 with a recording material 234. Print mechanism 226 may be configured for variable droplet or dot size to reproduce multiple intensity levels. Printable medium 232 comprises any type of material suitable for printing upon which recording material 234 is applied, such as paper (web or cut-sheet), plastic, card stock, transparent sheets, cloth, etc. In an embodiment, print mechanism 226 may include one or more printheads that are configured to jet or eject droplets of a print liquid, such as ink (e.g., water-based, solvent-based, oil-based, or UV-curable), through a plurality of orifices or nozzles. The orifices or nozzles may be grouped according to ink types (e.g., colors such as Cyan (C), Magenta (M), Yellow (Y), Key black (K) or formulas such as for pre-coat, image and protector coat, etc.), which may be referred to as color planes. In another embodiment, print mechanism 226 may include a drum that selectively collects electrically-charged powdered ink (toner), and transfers the toner to printable medium 232. Media conveyance device 230 may be configured to move printable medium 232 relative to print mechanism 226. In other embodiments, portions of print mechanism 226 may be configured to move relative to printable medium 232. Image forming apparatus 102 may include various other components not specifically illustrated in FIG. 2.

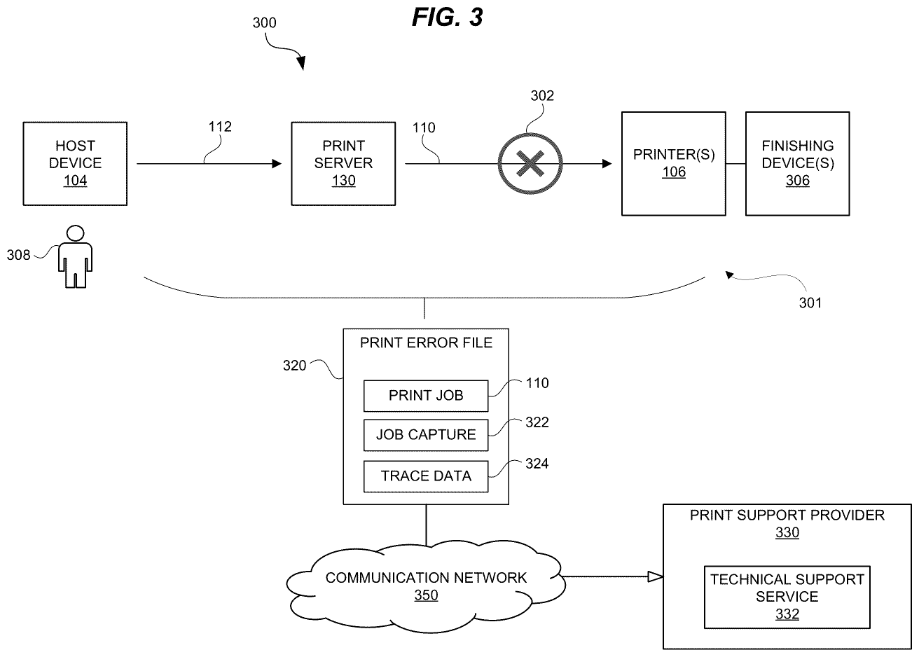

FIG. 3 is a block diagram of a print operation 300 in an illustrative embodiment. FIG. 3 illustrates one particular configuration of a print system 100 used in a print operation 300 comprising a host device 104, a print server 130, one or more printers 106, and one or more finishing devices 306 (e.g., post-processing devices). A configuration of a print system 100 by print operator 308 for a print operation 300 is referred to herein as a print configuration 301 of a print system 100. Although one print configuration 301 is illustrated in FIG. 3, other configurations are considered herein.

In a print operation 300 of a print job 110, there may be an error 302 (also referred to as a print error, printing error, printing process error, etc.) in printing of the print job 110. For example, an error 302 may occur at a printer 106 in processing of the print job 110, in rasterizing the print job 110, etc., which results in a printed output that is incorrect. In another example, an error 302 may occur at a finishing device 306 (e.g., binding, stapling, stitching, cutting/trimming, folding, creasing, sorting, hole punching, etc.) in post-print processing of printed output for the print job 110. In other examples, there may be an error 302 in the host device 104 in generating the print request 112 (e.g., a print file may be corrupted, a print file may be in an incompatible format, etc.), an error 302 in a print server 130 (e.g., an error in generating a print job 110 from a print request 112, an error in formatting (e.g., formatting of IPDS from an Advanced Function Presentation (AFP) request)), etc. In some scenarios, a print operator 308 may be able to diagnose the cause of an error 302 on-site, and resolve the error 302. In other scenarios, a print operator 308 may be unable to determine the cause of the error 302, and may utilize or contact a print support provider 330 to troubleshoot or debug the error 302. In an embodiment, a print support provider 330 may comprise a remote entity with respect to the print system 100, with expertise in analyzing and resolving errors 302 encountered in printing of print jobs 110. The print support provider 330 offers a technical support service 332 configured to diagnose errors 302 in print jobs 110. The technical support service 332 may be a fee-based service, may be a service offered by a manufacturer of a printer 106 or other type of print device 101, etc. Thus, in embodiments, the print operator 308 (e.g., through a client device, a portal, an on-site or on-ground agent, etc.) or print system 100 may provide a print error file(s) 320 to the print support provider 330, such as over a communication network 350.

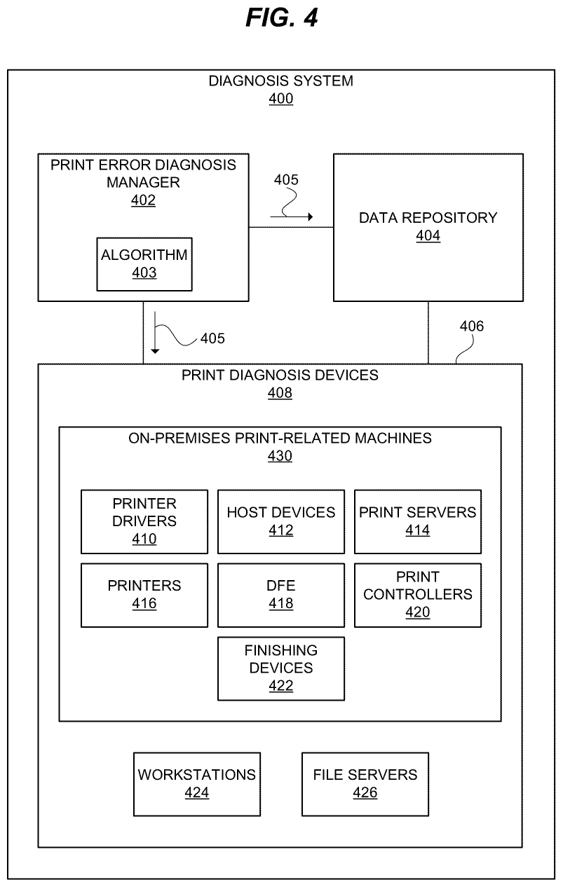

FIG. 4 is a block diagram of a diagnosis system 400 in an illustrative embodiment. A diagnosis system 400 as in FIG. 4 may be implemented by a print support provider 330 to provide a technical support service 332. Diagnosis system 400 comprises a print error diagnosis manager 402, which is an apparatus, device, circuitry, means, and/or other component configured to control, supervise, or manage diagnosis of errors 302. Print error diagnosis manager 402 may execute one or more algorithms 403 (also referred to as scripts or control files (e.g., Python files or files of another programming language)) to perform its functions, and output control signals 405 to other system(s). Diagnosis system 400 further comprises a data repository 404, which is an apparatus, device, circuitry, means, and/or other component configured to store data, such as in a secure manner. For example, data repository 404 may store data or information associated with an error 302 encountered with a print job 110, may store data associated with print devices 101, may store data associated with print operators 308, etc. Diagnosis system 400 may comprise a pool 406 of print diagnosis devices 408. A print diagnosis device 408 is an apparatus, device, circuitry, equipment, means, software, application, etc., configured to assist or support diagnosis of print errors. As will be described in further detail below, diagnosis system 400 attempts to recreate or reproduce at least part of the print environment employed by a print operator 308 when encountering an error 302 in printing. Thus, one or more of the print diagnosis devices 408 comprise equipment (i.e., comparable equipment) used in a print environment. For example, print diagnosis devices 408 may comprise printer drivers 410, host devices 412, print servers 414, printers 416, DFEs 418, print controllers 420, finishing devices 422, etc. Print diagnosis devices 408 may comprise workstations 424, file servers 426, etc. Diagnosis system 400 may be implemented in a test center or laboratory (i.e., a physical location), and at least some of the print diagnosis devices 408 may be on-ground or on-premises at the test center. These types of devices may be referred to as on-premises print-related machines 430. For example, an on-premises print-related machine 430 may comprise a production printer of a certain manufacturer and model number, a print controller for a production printer without an associated print engine, etc.

The diagnosis system 400 may comprise various other components not specifically illustrated in FIG. 4.

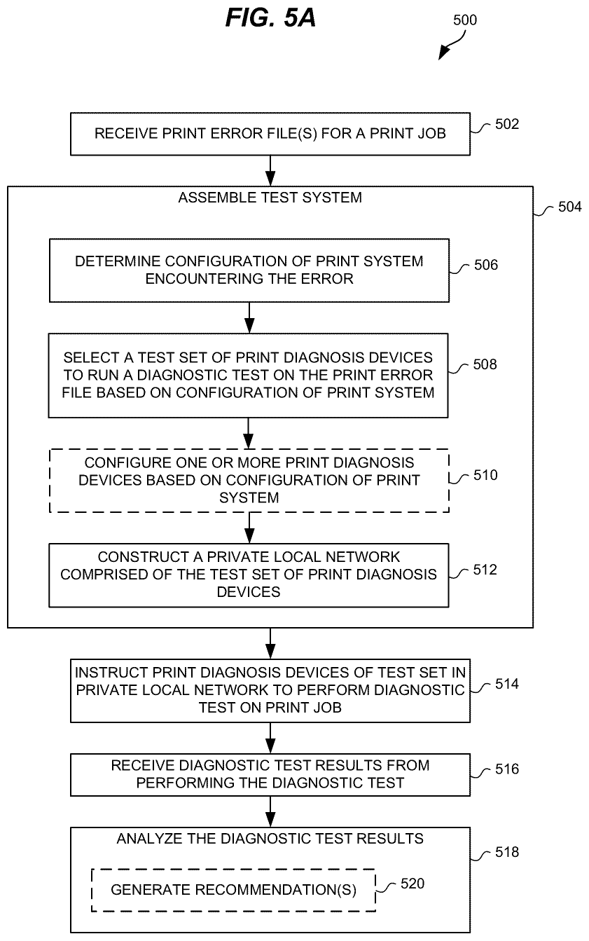

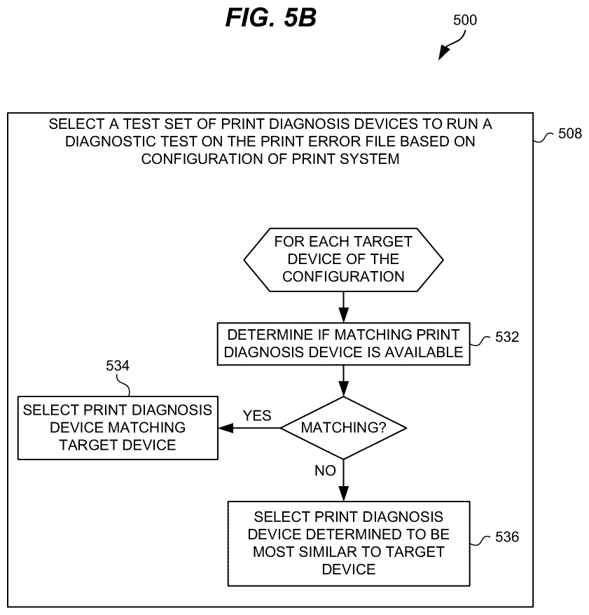

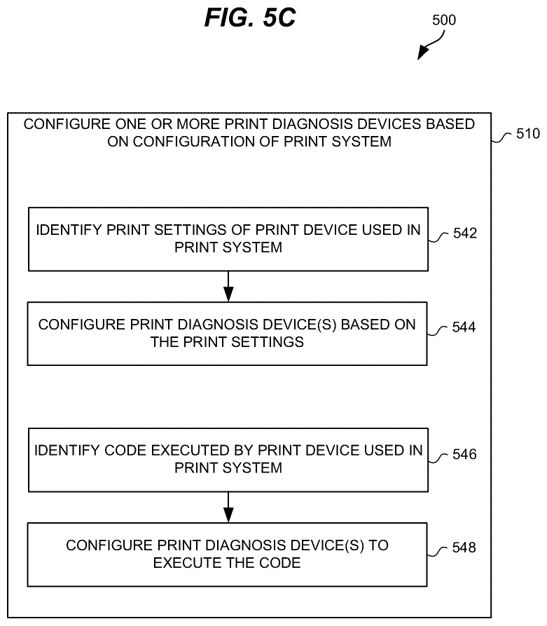

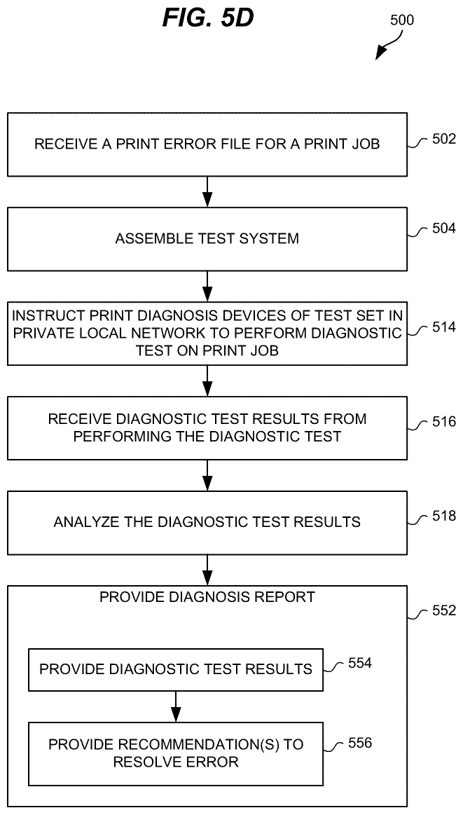

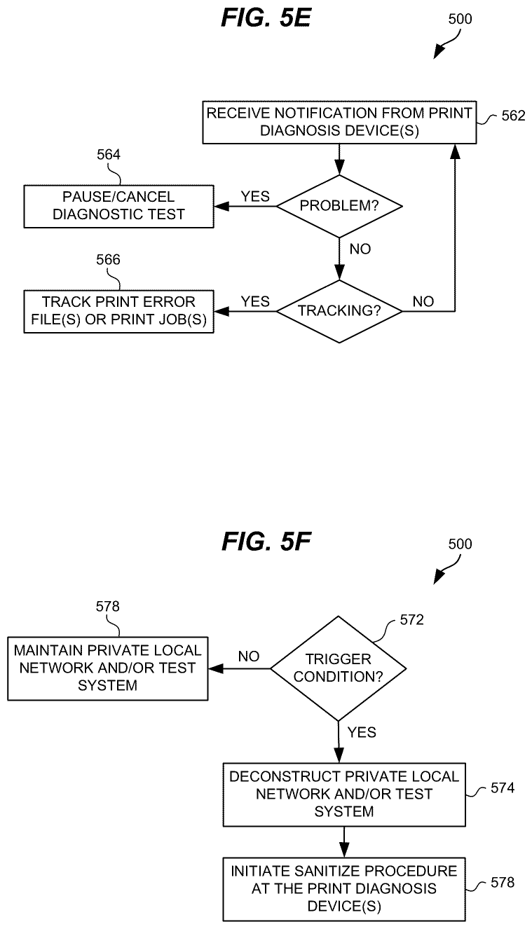

FIGS. 5A-5F are flow charts illustrating a method 500 of providing technical support in illustrative embodiments. The steps of method 500 will be described with reference to the print error diagnosis manager 402 in FIG. 4, but those skilled in the art will appreciate that the methods (also referred to as processes) described herein may be performed in other systems or devices. Also, the steps of the flow charts described herein are not all inclusive and may include other steps not shown, and the steps may be performed in an alternative order.

In FIG. 5A, print error diagnosis manager 402 receives one or more print error files 320 for a print job 110 (step 502). The print error file 320 (see FIG. 3) comprises information regarding an error 302 in printing a print job 110 (or multiple print jobs 110) at a print system 100 utilized by a print operator 308. For example, a print error file 320 may include or contain a copy of the print job 110, a job capture 322 (e.g., data or files processed by the host device 104 or print server 130 to produce print job 110, data output to a printer, etc.) associated with a target printer of the print system 100 that encountered a problem in printing the print job 110, trace data 324 (e.g., generated by the target printer or other devices in print system 100 in handling the print job 110), etc. However, the print error file 320 may include or contain other information as desired, such as operational logs (e.g., print engine logs), an error code(s) associated with the error 302, print system 100 settings, print device 101 settings, etc. As used herein, print device 101 settings may include operational parameter data (e.g., print resolution, copies, n-up, print speed, page length, fonts, finishing options, etc.) and metadata (printer manufacturer, printer model number, installed code, installed features, etc.). The print error file 320 may include statistical data calculated on-board, such as incoming data rates, print data throughput, total job print time, and/or histograms for various internal tasks and events. These are also useful for matching up to a diagnostic test that is attempting to reproduce a problem. Print error diagnosis manager 402 may also receive or acquire other information related to printing of the print job 110 at the print system 100, such as system settings, a print configuration implemented at the print system 100, etc. Print error diagnosis manager 402 stores the print error file(s) 320 and other related information in a data repository 404. In embodiments, print error diagnosis manager 402 may generate or update print error file 320 based on identified information from the print system 100 (e.g., print error file 320 is updated by adding error code data or adding print settings).

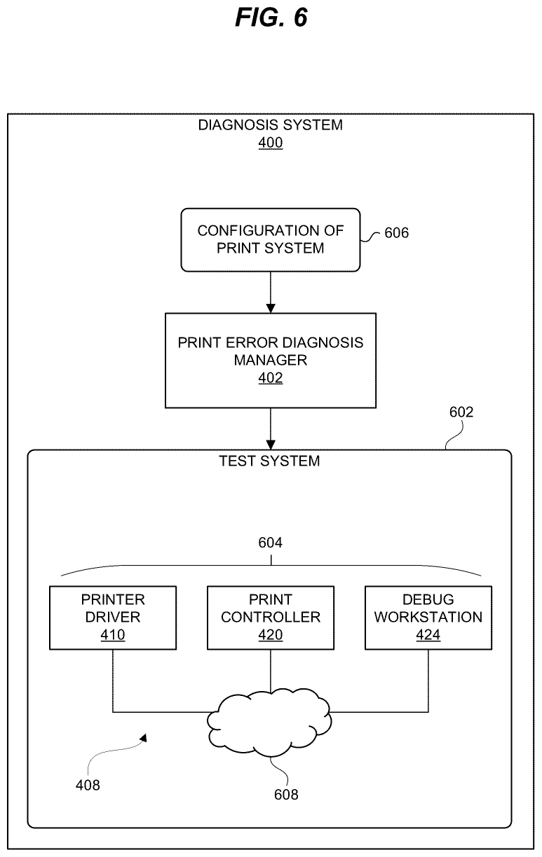

Print error diagnosis manager 402 builds, creates, or assembles a test system from one or more of the print diagnosis devices 408 available in the pool 406 (step 504). FIG. 6 is a block diagram of diagnosis system 400 in an illustrative embodiment. To create a test system 602, print error diagnosis manager 402 determines a configuration 606 of the print system 100 utilized by the print operator 308 that encountered the error 302 (see step 506 in FIG. 5A). For example, print error diagnosis manager 402 may identify a printer 106 (e.g., manufacturer, model number, etc.) of the print system 100, a print server 130 (e.g., model number, version number, etc.) of the print system 100, a host application used on a host device 104, a finishing device 306 of the print system 100, etc. Print error diagnosis manager 402 may store pre-defined information regarding the print system 100 of a print operator 308 indicating a configuration 606 of the print system 100. Print error diagnosis manager 402 may query the print operator 308 for information regarding the configuration 606 of the print system 100. Print error diagnosis manager 402 may receive information regarding the configuration 606 of the print system 100 as part of the print error file(s) 320 or as supplemental information provided with the print error file(s) 320.

Based on the configuration 606 of the print system 100, print error diagnosis manager 402 may (e.g., automatically) create, assemble, or build a test system 602 that emulates at least a portion of the print system 100 that encountered the error 302. For example, print error diagnosis manager 402 selects a set of one or more print diagnosis devices 408 (referred to as a test set 604) to run a diagnostic test on the print error file 320 based on the configuration 606 of the print system 100 (see step 508 in FIG. 5A). In other words, print error diagnosis manager 402 selects one or more print diagnosis devices 408 that resemble or approximate one or more print devices 101 used in the print system 100 of the print operator 308. A device used in the print system 100 of the print operator 308 may be referred to herein as a target device. For each target device, for example, print error diagnosis manager 402 may search the pool 406 of print diagnosis devices 408 to determine whether a comparable print diagnosis device 408 is available. In FIG. 5B, for example, print error diagnosis manager 402 may determine whether a print diagnosis device 408 is available that matches a target device in the configuration 606 of the print system 100 (step 532). When a matching print diagnosis device 408 is available, print error diagnosis manager 402 selects the matching print diagnosis device 408 for the test system 602 (step 534). When a matching print diagnosis device 408 is not available, print error diagnosis manager 402 selects a print diagnosis device 408 for the test system 602 that is most similar or most comparable to the target device (step 536). The selection of a device that is most similar or most comparable to a target device may be based on policies, rules, etc., predefined within the print error diagnosis manager 402. One technical benefit for building the test system 602 that emulates the print system 100 is to increase the likelihood of duplicating the error 302.

Assume, for example, that the print system 100 of a print operator 308 comprises a printer 106 (referred to as a target printer) that encountered a problem, issue, or error in printing the print job 110. The test system 602 (i.e., an on-premises print-related machine 430 of the test system 602) assembled by the print error diagnosis manager 402 may therefore comprise a printer 416 (also referred to as a test printer) corresponding or comparable with the target printer. In an embodiment, print error diagnosis manager 402 may select a test printer matching the target printer, such as according to manufacturer, model number, etc., when a matching test printer is available in the pool 406. In an embodiment, when a matching test printer is not available, print error diagnosis manager 402 may select a test printer determined to be most similar or comparable to the target printer. Assume, in another example, that the print system 100 of a print operator 308 comprises a print controller 214 (referred to as a target print controller) that encountered a problem, issue, or error in printing (e.g., rasterizing) the print job 110. The test system 602 (i.e., an on-premises print-related machine 430 of the test system 602) assembled by the print error diagnosis manager 402 may therefore comprise a print controller 420 (also referred to as a test print controller) corresponding or comparable with the target print controller. In an embodiment, print error diagnosis manager 402 may select a test print controller matching the target print controller, such as according to manufacturer, model number, etc., when a matching test print controller is available in the pool 406. In an embodiment, when a matching test print controller is not available, print error diagnosis manager 402 may select a test print controller determined to be most similar or comparable to the target print controller. Print error diagnosis manager 402 may select other devices of the test system 602 in a similar manner.

In the example shown in FIG. 6, the test system 602 includes a printer driver 410, a print controller 420, and a debug workstation 424. However, this is just an example, and the test system 602 may include other print diagnosis devices 408 based on the configuration 606 of the print system 100.

In FIG. 5A, print error diagnosis manager 402 may further configure one or more print diagnosis devices 408 of the test system 602 based on the configuration 606 of the print system 100 (optional step 510). In FIG. 5C, for example, print error diagnosis manager 402 may identify print settings of a print device(s) 101 used in the print system 100 of the print operator 308 (optional step 542), and configure one or more print diagnosis devices 408 of the test set 604 based on the print settings (see optional step 544). In another example, print error diagnosis manager 402 may identify code executed by a print device(s) 101 used in the print system 100 of the print operator 308 (optional step 546), and configure one or more print diagnosis devices 408 of the test set 604 to execute the identified code (optional step 548). Print error diagnosis manager 402 may provision or configure the test system 602 in other ways so that the test system 602 more closely emulates the configuration 606 of the print system 100. One technical benefit for building test system 602 to more closely emulate the print system 100 is to further increase the likelihood of duplicating the error 302.

In FIG. 5A, print error diagnosis manager 402 constructs a private local network 608 comprised of the test set 604 of print diagnosis devices 408 (step 512). These networked devices therefore comprise a test system 602 that is dynamically established or set up, such as in response to receiving a print error file 320, to run a diagnostic test. To construct the private local network 608, print error diagnosis manager 402 may determine or identify network addresses (and port numbers) of print diagnosis devices 408 selected for the test set 604, and dynamically configure the private local network 608 based on the configuration 606 of the print system 100. For example, if the print system 100 comprises a host device 104, a print server 130, and a printer 106, then print error diagnosis manager 402 may configure the private local network 608 so that a test host device 412 is able to communicate with a test print server 414, and the test print server 414 is able to communicate with a test printer 416.

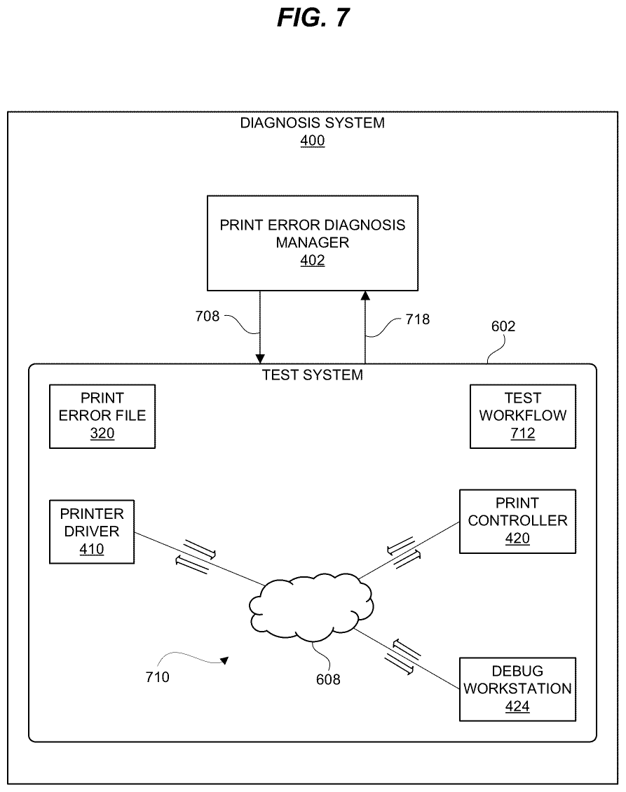

With the test system 602 assembled, print error diagnosis manager 402 instructs the test set 604 of print diagnosis devices 408 in the private local network 608 to perform (e.g., automatically) the diagnostic test on the print job 110 (step 514). FIG. 7 is a block diagram of diagnosis system 400 in an illustrative embodiment. In the example shown in FIG. 7, the test system 602 again includes a printer driver 410, a print controller 420, and a debug workstation 424. Print error diagnosis manager 402 controls the test system 602 to perform a diagnostic test 710 (or multiple tests) on the print job 110 based on the print error file 320, by sending instructions or commands 708 to the test system 602. For example, printer driver 410 may operate on information contained in the print error file 320, such as to generate a test print job (e.g., based on print job 110 or job capture 322), and submit the test print job to the print controller 420. Print controller 420, in turn, may rasterize one or more print files of the test print job to generate test bitmaps (or halftone test bitmaps). Debug workstation 424 may provide commands or instructions to printer driver 410 and/or print controller 420 to generate the test bitmaps, such as according to settings of the print system 100 of the print operator 308. One or more devices of test system 602 may operate based on a test workflow 712 that is predefined or generated by the print error diagnosis manager 402 based on the print error file 320. Test workflow 712 specifies steps to perform for a diagnostic test 710, rules or policies for performing the diagnostic test 710, parameters for performing the diagnostic test 710, etc.

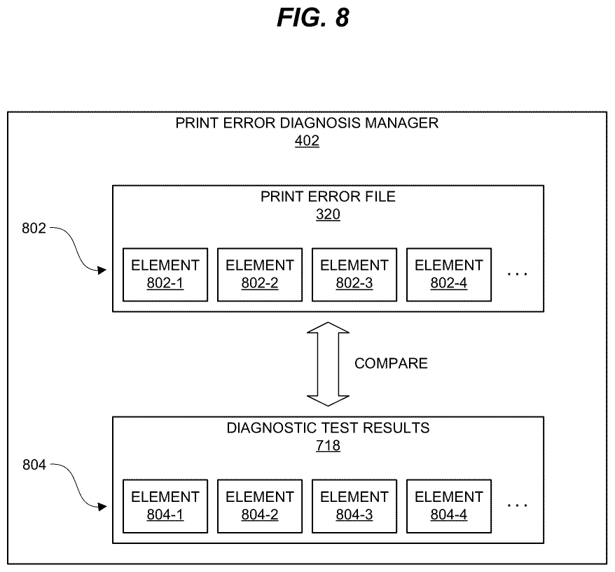

In FIG. 5A, print error diagnosis manager 402 receives diagnostic test results 718 from performing the diagnostic test 710 in the test system 602 (step 516). For example, one or more print diagnosis devices 408 in the test system 602 may report data regarding the diagnostic test 710 to print error diagnosis manager 402. In embodiments, diagnostic test results 718 may include elements comparable to those in print error file 320 (e.g., test error codes, test trace data, etc.). Print error diagnosis manager 402 may then analyze the diagnostic test results 718 (step 518). In an embodiment, print error diagnosis manager 402 may perform a comparison of elements of the diagnostic test results 718 to corresponding elements of the print error file 320 to identify differences. FIG. 8 is a block diagram illustrating analysis of diagnostic test results 718 in an illustrative embodiment. Print error file 320 may contain one or more elements 802 (e.g., element 802-1, element 802-2, element 802-3, element 802-4, etc.) that are used or identified for analysis of an error 302 in printing a print job 110. For example, an element 802 may comprise a Portable Document Format (PDF) file or objects (e.g., text, images, graphics, etc.) of a PDF file. In another example, elements 802 may comprise bitmaps generated by a print controller based on a print job. Diagnostic test results 718 may contain one or more elements 804 (e.g., element 804-1, element 804-2, element 804-3, element 804-4, etc.) generated based on the diagnostic test 710 performed on the print job 110. Print error diagnosis manager 402 may compare elements 804 of the diagnostic test results 718 to corresponding elements 802 of the print error file 320 to identify differences. For example, assume that elements of the print error file 320 contain bitmaps generated by a printer 106 of the print operator 308. The diagnostic test results 718 may contain test bitmaps as elements 804 generated by a comparable test print controller 420 or test printer 416 in the diagnostic test 710. Print error diagnosis manager 402 may compare the test bitmaps of the diagnostic test results 718 to corresponding bitmaps of the print error file to identify differences. In one embodiment, the print error file 320 includes at least trace data generated by the target printer in handling the print job 110, the diagnostic test results 718 include test traces, and the analyzing the diagnostic test results 718 comprises a comparison of the trace data and the test trace data. One technical benefit is the print error diagnosis manager 402 may diagnose a problem in printing a print job 110 from a remote location (e.g., off-site), which may improve the technical support offered to the print operator 308.

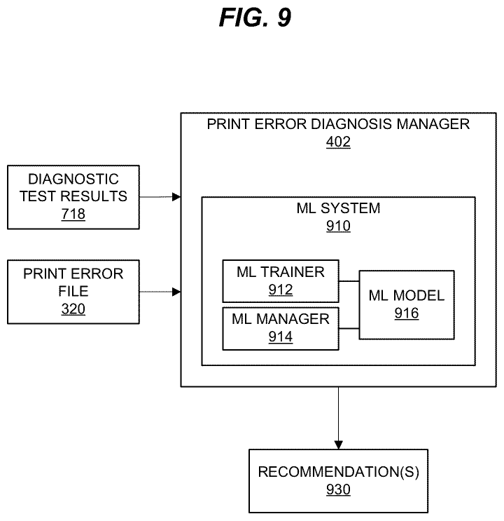

In analyzing the diagnostic test results 718, print error diagnosis manager 402 may generate one or more recommendations to resolve the error 302 (see optional step 520 in FIG. 5A), such as based on the comparison described above. In embodiments, recommendations to resolve error 302 may include human readable steps (or link to steps) intended to be performed by a human on print system 100 to resolve and/or further diagnose the error 302. FIG. 9 is a block diagram illustrating analysis of diagnostic test results 718 in an illustrative embodiment. Print error diagnosis manager 402 may analyze the diagnostic test results 718 to generate one or more recommendations 930 to resolve the error 302. In an embodiment, print error diagnosis manager 402 may implement one or more Artificial Intelligence (AI) or Machine Learning (ML) systems. As illustrated in FIG. 9, print error diagnosis manager 402 may implement an ML system 910 for analyzing print jobs, print error files, diagnostic test results, etc. An ML system 910 may comprise circuitry, logic, hardware, software, means, etc., configured to use machine learning techniques to perform functions described for print error diagnosis manager 402. In an embodiment, one or more ML models 916 are trained for ML system 910. In general, an ML model 916 is a program or algorithm that learns from training samples to make predictions or recommendations based on a set of input data, and/or perform other functions. ML system 910 may further include an ML trainer 912 and an ML manager 914. ML trainer 912 may comprise circuitry, logic, hardware, means, etc., configured to train and/or re-train one or more ML models 916. ML manager 914 may comprise circuitry, logic, hardware, means, etc., configured to manage one or more ML models 916 as trained. For example, ML manager 914 may be configured to input data into an ML model 916 during testing or after deployment, and receive output from the ML model 916, along with other functions. Print error diagnosis manager 402 may operate a ML model 916 trained to recommend solutions to printing errors. In an embodiment, the input data to the ML model 916 may comprise diagnostic test results 718, one or more print error files 320, and/or other data regarding printing of a print job 110, although other input data may be used. The (trained) ML model 916 may generate, as output, an indication or indications of a recommendation(s) 930 to resolve an error 302 in printing a print job 110. One technical benefit is the ML model 916 may provide improved accuracy and efficiency in solving printing errors.

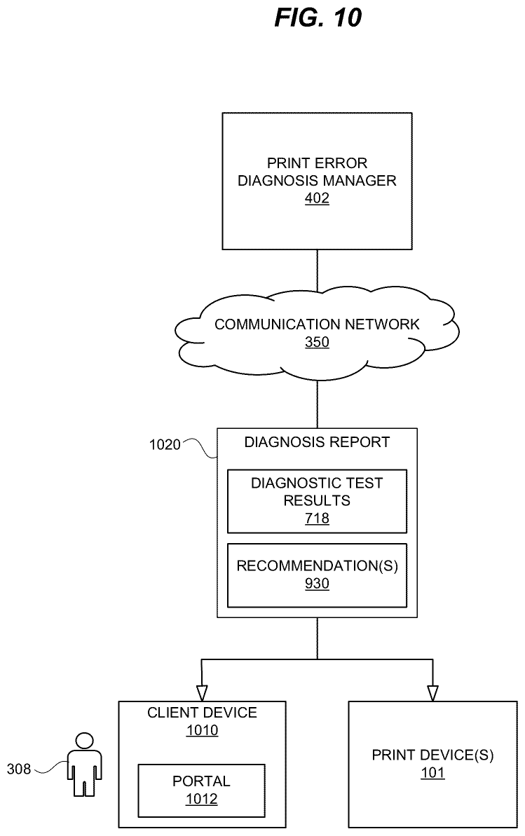

In FIG. 5D, print error diagnosis manager 402 may provide a diagnosis report to the print operator 308 or directly to a print device 101 configured to interpret the diagnosis report (optional step 552). FIG. 10 is a block diagram illustrating reporting of a diagnosis report in an illustrative embodiment. Print error diagnosis manager 402 may transmit, send, store, provide or otherwise make accessible, a diagnosis report 1020 to the print operator 308 or to a print device 101, such as over a communication network 350. In an embodiment, print error diagnosis manager 402 may provide the diagnostic test results 718 in the diagnosis report 1020 (see optional step 554 in FIG. 5D). In an embodiment, print error diagnosis manager 402 may provide one or more recommendations 930 in the diagnosis report 1020 (see optional step 556 in FIG. 5D). For example, the recommendation 930 may comprise human-readable steps or instructions to resolve an error 302. In another example, the recommendation 930 may comprise or may be linked to instructions or commands for a print device 101 to perform in an automated manner to resolve the error 302. However, other information may be provided in the diagnosis report 1020 as desired. Print error diagnosis manager 402 may send the diagnosis report 1020 to a client device 1010 of the print operator 308, through a portal 1012, or in another manner (e.g., email, file transfer, etc.), and/or may send at least a portion of the diagnosis report 1020 directly to one or more print devices 101. One technical benefit is the error 302 may be efficiently and effectively resolved based on the diagnosis report 1020.

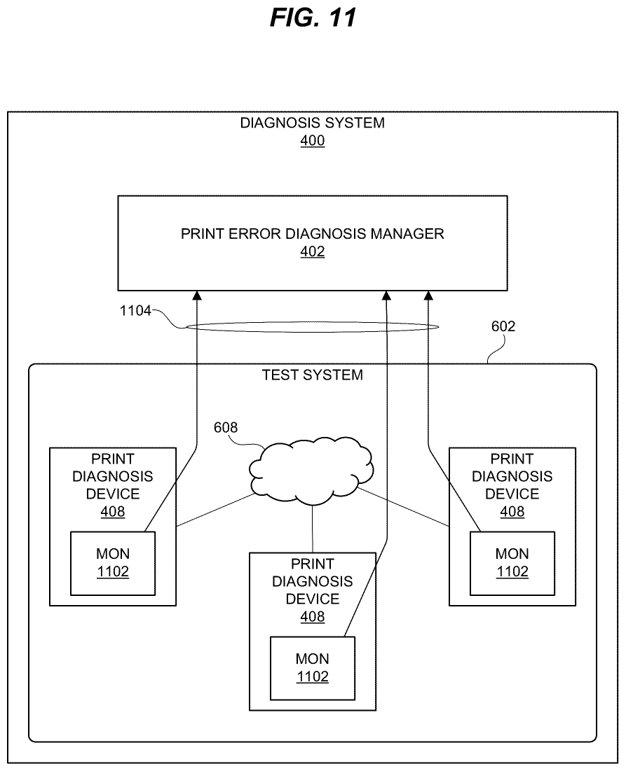

During diagnostic testing, print diagnosis devices 408 of a test system 602 may perform self-monitoring to determine operating status, states, conditions, etc. FIG. 11 is a block diagram illustrating self-monitoring within a diagnosis system 400 in an illustrative embodiment. Each print diagnosis device 408 may comprise a self-monitoring program (e.g., a monitor 1102 (MON)) configured to detect information, events, etc., occurring within the print diagnosis device 408. For example, if an internal processing error is detected within the print diagnosis device 408, then monitor 1102 may be configured to send a notification 1104 to the print error diagnosis manager 402 indicating the processing error. In another example, if a security breach, vulnerability, or threat is detected within the print diagnosis device 408, then monitor 1102 may be configured to send a notification 1104 to the print error diagnosis manager 402 indicating the security breach. In another example, monitor 1102 may track what data or information is being processed within a print diagnosis device 408. For example, monitor 1102 may track what print error file 320 and/or print job 110 is being processed as part of a diagnostic test 710, and send a notification to the print error diagnosis manager 402 with tracking information indicating a print error file(s) 320 or print job(s) 110 is being handled. One technical benefit is the print diagnosis devices 408 are able to provide feedback to the print error diagnosis manager 402 so that print error diagnosis manager 402 maintains a holistic view of the test system 602.

Print error diagnosis manager 402 may perform a variety of functions in response to notifications 1104 from the print diagnosis devices 408. In FIG. 5E, for example, print error diagnosis manager 402 may receive notifications 1104 from one or more of the print diagnosis devices 408 in the test set 602 (step 562). When a notification 1104 (also referred to as a self-monitoring notification) indicates a problem (e.g., processing error, security breach, etc.), print error diagnosis manager 402 may pause or cancel the diagnostic test 710 (step 564). One technical benefit is the print error diagnosis manager 402 may react to certain events occurring in one or more print diagnosis devices 408. When a notification 1104 (also referred to as a tracking notification) indicates a print error file(s) 320 or print job(s) 110 being handled, print error diagnosis manager 402 tracks processing of the print error file(s) 320 or print job(s) 110 based on the notification 1104 (step 566). One technical benefit is the print error diagnosis manager 402 may track which of the print diagnosis devices 408 in a test set 602 processed a print error file(s) 320 or print job(s) 110.

After the diagnostic test 710, print error diagnosis manager 402 may determine whether other print error files 320 for other print jobs 110 (from the same print operator 308 or a different operator) are stored in data repository 404, and used a similar print system 100 that encountered an error 302. In other words, the technical support service 332 may receive print errors files 320 regarding print errors in similar types of print systems 100 that were used for the present diagnostic test 710. In such cases, print error diagnosis manager 402 may run diagnostic tests 710 using the same or similar test system 602 that was assembled. It is noted that the test system 602 may be re-initialized before a next diagnostic test 710. One technical benefit is the test system 602 may be reused for multiple diagnostic tests 710, which is more efficient.

At some point, print error diagnosis manager 402 may tear down the private local network 608 and/or the test system 602. In FIG. 5F, for example, if/when a trigger condition is detected (step 572), print error diagnosis manager 402 deconstructs the private local network 608 and/or the test system 602 (step 574). For example, after testing with the test system 602 is completed, print error diagnosis manager 402 may deconstruct the private local network 608. In another example, print error diagnosis manager 402 may deconstruct the private local network 608 if/when a problem has occurred in a diagnostic test 710, if/when a security breach has been detected, in response to a message or instruction from the print operator 308 (e.g., that the error 302 was fixed), etc. One technical benefit is the resources (e.g., print diagnosis devices 408) of the test system 602 may be returned to the pool 406 for other diagnostic tests 710. If a trigger condition is not detected, print error diagnosis manager 402 may maintain the private local network 608 and/or the test system 602 (step 578).

After deconstructing the private local network 608 and/or the test system 602, print error diagnosis manager 402 may initiate a sanitize procedure at print diagnosis devices 408 in the test set 604 to remove data related to the print error file(s) 320 and/or print job(s) 110 (step 578). For example, the sanitize procedure may delete or remove any data related to the print error file(s) 320 and/or print job(s) 110 from memory, buffers, or other storage media. For a sanitize procedure, a print diagnosis device 408 may be isolated from the other print diagnosis devices 408, such as in the secure network. This may be equivalent to a quarantine state. The print diagnosis device 408 remains isolated while being sanitized, after which the print diagnosis device 408 may be returned to the pool 406. One technical benefit is some data related to a print error file(s) 320 and/or print job(s) 110 may be considered sensitive data, and this sensitive data is removed from the print diagnosis devices 408 before being returned to the pool 406.

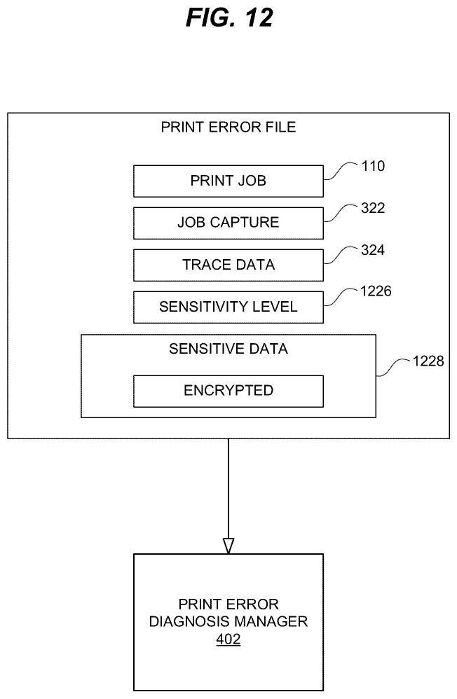

In embodiments described herein, the print error file(s) 320 and/or print job(s) 110 may contain sensitive data, which is any kind of information protected against unwarranted disclosure, such as personal information, banking information, credit card information, Protected Health Information (PHI), etc. FIG. 12 is a block diagram illustrating print error diagnosis manager 402 receiving one or more print error files 320 in an illustrative embodiment. As above, a print error file 320 for a print job 110 comprises information regarding an error 302 in printing a print job 110 (or multiple print jobs 110) at a print system 100 utilized by a print operator 308. For example, a print error file 320 may include or contain a copy of the print job 110, a job capture 322 of the print job 110 associated with a target printer of the print system 100 that encountered a problem in printing the print job 110, trace data 324 generated by the target printer in handling the print job 110, etc. Any of the print job 110, job capture 322, trace data 324, or other information in the print error file(s) 320 may contain sensitive data 1228. When a print error file 320 contains sensitive data 1228, at least a portion of the sensitive data 1228 may be encrypted. Thus, print error diagnosis manager 402 may store the print error file(s) 320 and other related information in a data repository 404 with the sensitive data 1228 encrypted. The print error file 320 may further comprise a sensitivity level 1226 associated with the print job 110, such as “low”, “medium”, and “high” or some other sensitivity levels.

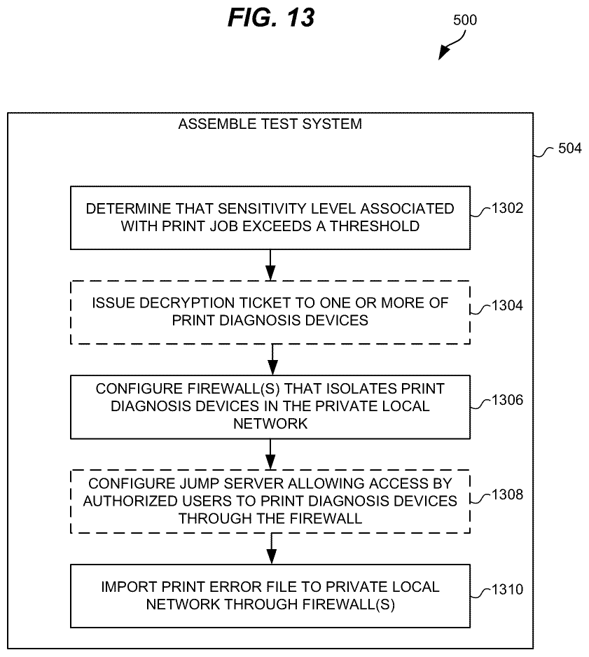

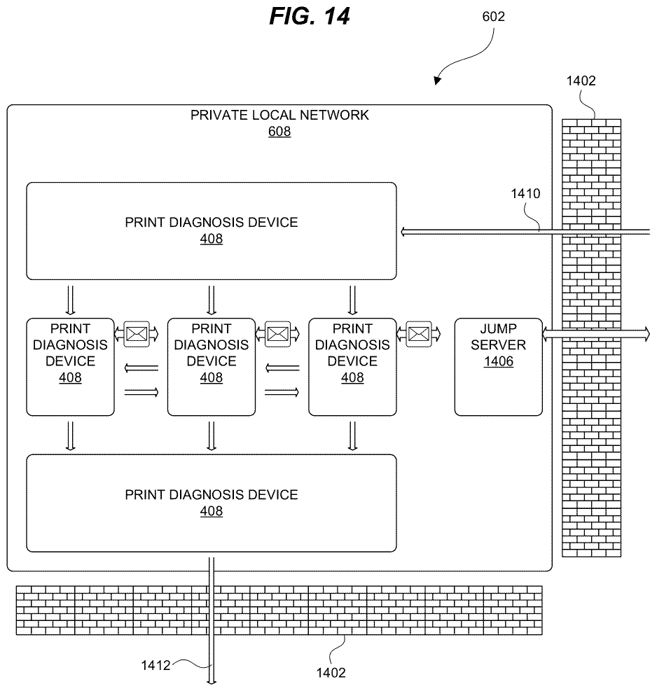

When receiving a print error file(s) 320 that contains sensitive data 1228, print error diagnosis manager 402 may operate as described above to build a test system 602 from one or more of the print diagnosis devices 408 (see step 504 in FIG. 5A) by determining a configuration 606 of the print system 100 utilized by the print operator 308 that encountered the error 302 (see step 506 in FIG. 5A), selecting a test set 604 of print diagnosis devices 408 to run a diagnostic test 710 on the print error file 320 based on the configuration 606 of the print system 100 (see step 508 in FIG. 5A), configuring one or more print diagnosis devices 408 of the test system 602 based on the configuration 606 of the print system 100 (see optional step 510 in FIG. 5A), and constructing a private local network 608 comprised of the test set 604 of print diagnosis devices 408 (see step 512 in FIG. 5A). FIG. 13 is a flow chart illustrating additional steps of method 500 in FIG. 5A in an illustrative embodiment. Print error diagnosis manager 402 determines that the sensitivity level 1226 associated with the print job 110 exceeds a threshold (step 1302). When the sensitivity level 1226 exceeds the threshold, print error diagnosis manager 402 configures at least one firewall that isolates the test set 602 of print diagnosis devices 408 in the private local network 608 (step 1306). FIG. 14 is a block diagram illustrating a private local network 608 in an illustrative embodiment. In this embodiment, the test system 602 includes a plurality of print diagnosis devices 408 that are connected to form a private local network 608. Print error diagnosis manager 402 configures a firewall 1402 (or multiple firewalls) that isolates the print diagnosis devices 408 in the private local network 608. In other words, print error diagnosis manager 402 dynamically updates rules on the firewall 1402 to restrict ingress traffic to the private local network 608 and restrict egress traffic from the private local network 608. Thus, there is an ingress point 1410 or ingress path into the private local network 608 (e.g., to an inbound file server 426), and an egress point 1412 or egress path out of the private local network 608 (e.g., from an outbound file server 426). Print error diagnosis manager 402 may import the print error file(s) 320 to the private local network 608 through the firewall(s) 1402 (step 1310). With the print error file(s) 320 imported to the private local network 608 through the ingress point 1410, print error diagnosis manager 402 may instruct the test set 604 of print diagnosis devices 408 in the private local network 608 to perform (e.g., automatically) the diagnostic test 710 on the print job 110 (see step 514 in FIG. 5A). One technical benefit is the private local network 608 is secure for a diagnostic test 710 through firewalling.

When sensitive data 1228 is encrypted, print error diagnosis manager 402 may issue a decryption ticket to one or more of the print diagnosis devices 408 before or after configuring the firewall 1402 (see optional step 1304 in FIG. 13). The decryption ticket comprises information enabling decryption of at least a portion of the print error file 320 that is encrypted, such as authorization for a print diagnosis device 408 to decrypt data, a decryption key, etc. One technical benefit is a decryption ticketing process allows the print error diagnosis manager 402 to control which print diagnosis devices 408 are able to decrypt data within the private local network 608.

Print error diagnosis manager 402 may also configure a jump server 1406 on the private local network 608 allowing access by one or more authorized users or individuals to the print diagnosis device(s) 408 through the firewall(s) 1402 (see optional step 1308 in FIG. 13). For example, a user may issue an access request, for example, to the print error diagnosis manager 402. The print error diagnosis manager 402 may confirm authorization credentials for the user to access the private local network 608, such as according to rules associated with the print error file 320 or the private local network 608. The print error diagnosis manager 402 may store a roster of user names (or identity) and a highest security level associated with that user. When a user is authorized, print error diagnosis manager 402 may configure the jump server 1406 to allow the user to access the private local network 608. Print error diagnosis manager 402 may also request that the user enter a user ID and password for authentication. One technical benefit is authorized users are able to communicate with one or more of the print diagnosis devices 408 during a diagnostic test 710 even though the firewall 1402 is established.

As described above, print error diagnosis manager 402 may monitor each of the print diagnosis devices 408 (e.g., based on monitor rules) to detect conditions deemed to be illegal or pose a risk. For example, each print diagnosis device 408 may run a self-monitoring program to determine whether utilities are missing or tampered with, unauthorized programs are loaded, network address changed, device has been reBOSd, etc. Print error diagnosis manager 402 may receive notifications 1104 from the print diagnosis devices 408 of the private local network 608, and pause or cancel a diagnostic test 710, such as when a notification 1104 indicates a security breach. Print error diagnosis manager 402 may also quarantine one or more of the print diagnosis devices 408. While in quarantine, print error diagnosis manager 402 may run diagnostic tools to evaluate the condition of the print diagnosis device 408. If the condition is repaired, then the print diagnosis device 408 may be moved back to the private local network 608. Otherwise, print diagnosis device 408 remains in quarantine until manually repaired, or reBOSd.

The diagnostic test 710 produces diagnostic test results 718, such as a diagnosis file indicating results of the diagnostic test 710. Print error diagnosis manager 402 may instruct one or more of the print diagnosis devices 408 to encrypt the diagnostic test results 718. Print error diagnosis manager 402 may export the encrypted diagnostic test results 718 from the private local network 608 through the firewall(s) 1402 (e.g., through egress point 1412). One technical benefit is the diagnostic test results 718 are protected in the event that they contain sensitive data.

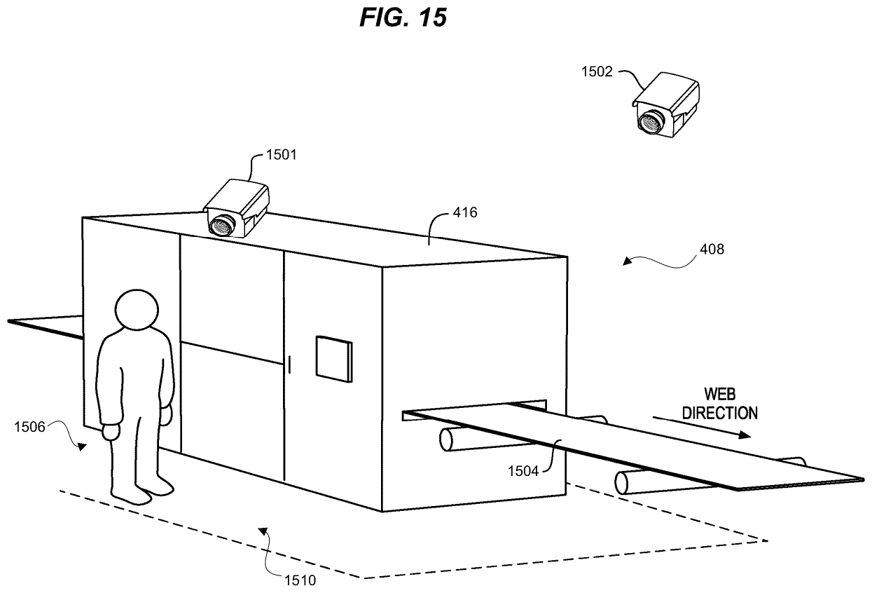

In an embodiment, print error diagnosis manager 402 may determine whether unauthorized users or personnel are in the vicinity of print diagnosis devices 408 (i.e., on-premises print-related machines 430 that are part of a private local network 608). For example, an on-premises print-related machine 430 may comprise a test printer 416 that is instructed to print at least a portion of the print job 110 as part of a diagnostic test 710. FIG. 15 shows a test printer 416 in an illustrative embodiment. As shown in this example, the test printer 416 may comprise a continuous-form printer that prints on a web 1504 of continuous-form media, such as paper. However, embodiments described herein may apply to alternative print systems such as cut-sheet printers, wide format printers, 3D printers, electrophotographic printers, etc. Test printer 416 is enhanced to use one or more imaging devices 1501-1502, such as a camera, to determine whether a person 1506 (also referred to as a user, personnel, tester, etc.) is authorized to be present in an operating space 1510 of the test printer 416. The imaging devices 1501-1502 provide a field of view of an operating space 1510 around the test printer 416. For example, one or more first imaging devices 1501 may be mounted to the test printer 416, and one or more second imaging devices 1502 may be mounted elsewhere in a room, such as a ceiling above the test printer 416. Print error diagnosis manager 402 may store identification data, such as clothing features (e.g., color, type, badge, etc.) and/or features of an individual's body/face (e.g., hair color, height, eye color, etc.). Based on image data captured by the imaging devices 1501-1502, print error diagnosis manager 402 may determine whether a person 1506 is authorized to be in the operating space 1510 of the test printer 416. Although a test printer 416 is illustrated in FIG. 15, monitoring may be performed on other types of print diagnosis devices 408.

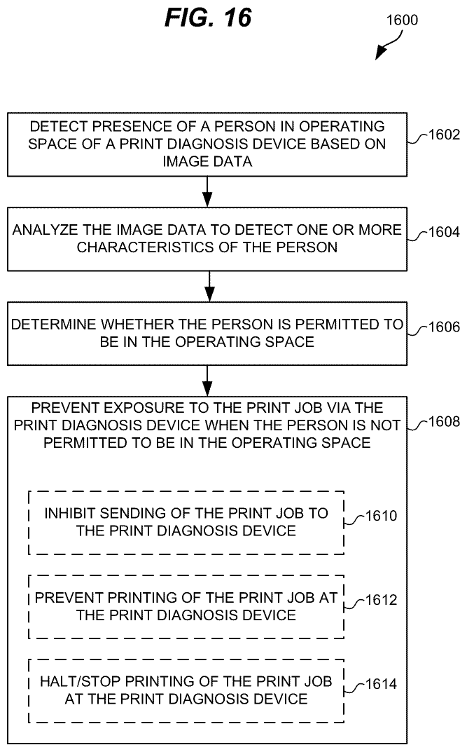

FIG. 16 is a flow chart illustrating a method 1600 of monitoring a print diagnosis device 408 in an illustrative embodiment. Print error diagnosis manager 402 detects a presence of a person 1506 in an operating space 1510 of a print diagnosis device 408 based on image data received from an imaging device 1501-1502 monitoring the operating space 1510 (step 1602), and analyzes the image data to detect one or more characteristics of the person 1506 (step 1604), such as clothing features (e.g., color, type, badge, etc.) and/or features of an individual's body/face (e.g., hair color, height, eye color, etc.). Print error diagnosis manager 402 determines whether the person 1506 is permitted to be in the operating space 1510 (step 1606), and prevents exposure to the print job 110 (e.g., sensitive data 1228 of the print job 110) via the print diagnosis device 408 when the person 1506 is not permitted to be in the operating space 1510 (step 1608). For example, print error diagnosis manager 402 may inhibit sending of the print job 110 to the print diagnosis device 408 (optional step 1610), may prevent printing of the print job 110 at the print diagnosis device 408 (optional step 1612), may halt or stop printing (optional step 1614), etc. One technical benefit is sensitive data 1228 of a print job 110 may be protected.

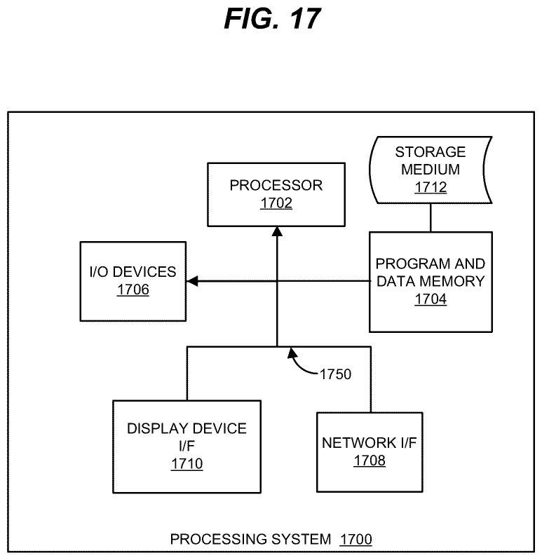

Embodiments disclosed herein can take the form of software, hardware, firmware, or various combinations thereof. FIG. 17 illustrates a processing system 1700 operable to execute a computer readable medium embodying programmed instructions to perform desired functions in an illustrative embodiment. Processing system 1700 is operable to perform the above operations by executing programmed instructions tangibly embodied on computer readable storage medium 1712. In this regard, embodiments can take the form of a computer program accessible via computer-readable medium 1712 providing program code for use by a computer or any other instruction execution system. For the purposes of this description, computer readable storage medium 1712 can be anything that can contain or store the program for use by the computer.

Computer readable storage medium 1712 can be an electronic, magnetic, optical, electromagnetic, infrared, or semiconductor device. Examples of computer readable storage medium 1712 include a solid-state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

Processing system 1700, being suitable for storing and/or executing the program code, includes at least one processor 1702 coupled to program and data memory 1704 through a system bus 1750. Program and data memory 1704 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 1706 (including but not limited to keyboards, displays, pointing devices, etc.) can be coupled either directly or through intervening I/O controllers. Network adapter interfaces 1708 may also be integrated with the system to enable processing system 1700 to become coupled to other data processing systems or storage devices through intervening private or public networks. Modems, cable modems, IBM Channel attachments, SCSI, Fibre Channel, and Ethernet cards are just a few of the currently available types of network or host interface adapters. Display device interface 1710 may be integrated with the system to interface to one or more display devices, such as printing systems and screens for presentation of data generated by processor 1702.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system according to embodiments and examples described herein.

Some embodiments pertain to Example 1 that includes an apparatus comprising a print error diagnosis manager comprising at least one processor and memory. The at least one processor is configured to cause the print error diagnosis manager at least to receive a print error file comprising information regarding an error in printing a print job at a print system, determine a configuration of the print system, select a test set of print diagnosis devices from a pool of the print diagnosis devices to run a diagnostic test on the print error file based on the configuration of the print system, wherein the test set of the print diagnosis devices includes at least one on-premises print-related machine, construct a private local network comprised of the test set of the print diagnosis devices, instruct the test set of the print diagnosis devices in the private local network to perform the diagnostic test on the print job, receive diagnostic test results from performing the diagnostic test, and analyze the diagnostic test results by performing a comparison of elements of the diagnostic test results to corresponding elements of the print error file to identify differences.

Example 2 includes the subject matter of Example 1, where the at least one processor is further configured to cause the print error diagnosis manager at least to generate at least one recommendation to resolve the error based on the comparison, and provide the at least one recommendation.

Example 3 includes the subject matter of Examples 1 and 2, where the print system comprises at least one print-related device, and the at least one processor is further configured to cause the print error diagnosis manager at least to identify print settings of the at least one print-related device, and configure the test set of the print diagnosis devices based on the print settings.

Example 4 includes the subject matter of Examples 1-3, where the print system comprises at least one print-related device, and the at least one processor is further configured to cause the print error diagnosis manager at least to identify code executed by the at least one print-related device, and configure the test set of the print diagnosis devices to execute the identified code.

Example 5 includes the subject matter of Examples 1-4, where the print error file includes at least trace data generated by a target printer in handling the print job, the diagnostic test results include test traces, and analyzing the diagnostic test results comprises a comparison of the trace data and the test trace data.

Example 6 includes the subject matter of Examples 1-5, where the print system comprises a target printer that encountered the error in printing the print job, and the at least one on-premises print-related machine comprises a test printer corresponding with the target printer.

Example 7 includes the subject matter of Examples 1-6, where the at least one processor is further configured to cause the print error diagnosis manager at least to select the test printer from a plurality of on-premises print-related machines determined to be most similar to the target printer.

Example 8 includes the subject matter of Examples 1-7, where the print system comprises a target print controller that encountered the error in rasterizing the print job, and the at least one on-premises print-related machine comprises a test print controller corresponding with the target print controller.

Example 9 includes the subject matter of Examples 1-8, where the at least one processor is further configured to cause the print error diagnosis manager at least to select the test print controller from a plurality of on-premises print-related machines determined to be most similar to the target print controller.

Example 10 includes the subject matter of Examples 1-9, where the at least one processor is further configured to cause the print error diagnosis manager at least to determine that a sensitivity level associated with the print job exceeds a threshold, configure at least one firewall that isolates the test set of the print diagnosis devices in the private local network, and import the print error file to the private local network through the at least one firewall.

Example 11 includes the subject matter of Examples 1-10, where the at least one processor is further configured to cause the print error diagnosis manager at least to issue a decryption ticket to at least one of the print diagnosis devices in the test set enabling decryption of at least a portion of the print error file that is encrypted.

Example 12 includes the subject matter of Examples 1-11, where the at least one processor is further configured to cause the print error diagnosis manager at least to configure a jump server on the private local network allowing access by at least one authorized user to one or more of the print diagnosis devices in the test set through the at least one firewall.

Example 13 includes the subject matter of Examples 1-12, where the at least one processor is further configured to cause the print error diagnosis manager at least to receive notifications from the print diagnosis devices in the test set, and track which of the print diagnosis devices in the test set processed the print job based on the notifications.

Example 14 includes the subject matter of Examples 1-13, where the at least one processor is further configured to cause the print error diagnosis manager at least to deconstruct the private local network in response to a trigger condition.

Example 15 includes the subject matter of Examples 1-14, where the at least one processor is further configured to cause the print error diagnosis manager at least to initiate a sanitize procedure at the print diagnosis devices in the test set to remove data related to the print error file.

Example 16 includes the subject matter of Examples 1-15, where the at least one processor is further configured to cause the print error diagnosis manager at least to receive notifications from the print diagnosis devices in the test set, and pause or cancel the diagnostic test when a notification indicates a security breach.

Example 17 includes the subject matter of Examples 1-16, where the at least one processor is further configured to cause the print error diagnosis manager at least to detect a presence of a person in an operating space of at least one of the print diagnosis devices in the test set based on image data received from an imaging device monitoring the operating space, analyze the image data to detect one or more characteristics of the person, determine whether the person is permitted to be in the operating space, and prevent exposure to the print job via the at least one of the print diagnosis devices when the person is not permitted to be in the operating space.

Example 18 includes the subject matter of Examples 1-17, comprising the at least one on-premises print-related machine.

Some embodiments pertain to Example 19 that includes a method comprising receiving a print error file comprising information regarding an error in printing a print job at a print system, determining a configuration of the print system, selecting a test set of print diagnosis devices from a pool of the print diagnosis devices to run a diagnostic test on the print error file based on the configuration of the print system, wherein the test set of the print diagnosis devices includes at least one on-premises print-related machine, constructing a private local network comprised of the test set of the print diagnosis devices, instructing the test set of the print diagnosis devices in the private local network to perform the diagnostic test on the print job, receiving diagnostic test results from performing the diagnostic test, and analyzing the diagnostic test results by performing a comparison of elements of the diagnostic test results to corresponding elements of the print error file to identify differences.

Some embodiments pertain to Example 20 that includes a non-transitory computer readable medium embodying programmed instructions executed by a processor, where the instructions direct the processor to implement a method comprising receiving a print error file comprising information regarding an error in printing a print job at a print system, determining a configuration of the print system, selecting a test set of print diagnosis devices from a pool of the print diagnosis devices to run a diagnostic test on the print error file based on the configuration of the print system, wherein the test set of the print diagnosis devices includes at least one on-premises print-related machine, constructing a private local network comprised of the test set of the print diagnosis devices, instructing the test set of the print diagnosis devices in the private local network to perform the diagnostic test on the print job, receiving diagnostic test results from performing the diagnostic test, and analyzing the diagnostic test results by performing a comparison of elements of the diagnostic test results to corresponding elements of the print error file to identify differences.

Although specific embodiments were described herein, the scope of the invention is not limited to those specific embodiments. The scope of the invention is defined by the following claims and any equivalents thereof.

What is claimed is:

1. An apparatus, comprising:
a print error diagnosis manager comprising at least one processor and memory;
the at least one processor configured to cause the print error diagnosis manager at least to:
receive a print error file comprising information regarding an error in printing a print job at a print system;
determine a configuration of the print system;
select a test set of print diagnosis devices from a pool of the print diagnosis devices to run a diagnostic test on the print error file based on the configuration of the print system, wherein the test set of the print diagnosis devices includes at least one on-premises print-related machine;
construct a private local network comprised of the test set of the print diagnosis devices;
instruct the test set of the print diagnosis devices in the private local network to perform the diagnostic test on the print job;
receive diagnostic test results from performing the diagnostic test; and
analyze the diagnostic test results by performing a comparison of elements of the diagnostic test results to corresponding elements of the print error file to identify differences.

2. The apparatus of claim 1, wherein the at least one processor is further configured to cause the print error diagnosis manager at least to:
generate at least one recommendation to resolve the error based on the comparison; and
provide the at least one recommendation.

3. The apparatus of claim 1, wherein:
the print system comprises at least one print-related device; and
the at least one processor is further configured to cause the print error diagnosis manager at least to:
identify print settings of the at least one print-related device; and
configure the test set of the print diagnosis devices based on the print settings.

4. The apparatus of claim 1, wherein:
the print system comprises at least one print-related device; and
the at least one processor is further configured to cause the print error diagnosis manager at least to:
identify code executed by the at least one print-related device; and
configure the test set of the print diagnosis devices to execute the identified code.

5. The apparatus of claim 1, wherein:
the print error file includes at least trace data generated by a target printer in handling the print job, the diagnostic test results include test traces, and analyzing the diagnostic test results comprises a comparison of the trace data and the test trace data.

6. The apparatus of claim 1, wherein:
the print system comprises a target printer that encountered the error in printing the print job; and
the at least one on-premises print-related machine comprises a test printer corresponding with the target printer.

7. The apparatus of claim 6, wherein the at least one processor is further configured to cause the print error diagnosis manager at least to:
select the test printer from a plurality of on-premises print-related machines determined to be most similar to the target printer.

8. The apparatus of claim 1, wherein:
the print system comprises a target print controller that encountered the error in rasterizing the print job; and
the at least one on-premises print-related machine comprises a test print controller corresponding with the target print controller.

9. The apparatus of claim 8, wherein the at least one processor is further configured to cause the print error diagnosis manager at least to:
select the test print controller from a plurality of on-premises print-related machines determined to be most similar to the target print controller.

10. The apparatus of claim 1, wherein the at least one processor is further configured to cause the print error diagnosis manager at least to:
determine that a sensitivity level associated with the print job exceeds a threshold;
configure at least one firewall that isolates the test set of the print diagnosis devices in the private local network; and
import the print error file to the private local network through the at least one firewall.

11. The apparatus of claim 10, wherein the at least one processor is further configured to cause the print error diagnosis manager at least to:
issue a decryption ticket to at least one of the print diagnosis devices in the test set enabling decryption of at least a portion of the print error file that is encrypted.

12. The apparatus of claim 10, wherein the at least one processor is further configured to cause the print error diagnosis manager at least to:
configure a jump server on the private local network allowing access by at least one authorized user to one or more of the print diagnosis devices in the test set through the at least one firewall.

13. The apparatus of claim 1, wherein the at least one processor is further configured to cause the print error diagnosis manager at least to:
receive notifications from the print diagnosis devices in the test set; and
track which of the print diagnosis devices in the test set processed the print job based on the notifications.

14. The apparatus of claim 1, wherein the at least one processor is further configured to cause the print error diagnosis manager at least to:
deconstruct the private local network in response to a trigger condition.

15. The apparatus of claim 14, wherein the at least one processor is further configured to cause the print error diagnosis manager at least to:
initiate a sanitize procedure at the print diagnosis devices in the test set to remove data related to the print error file.

16. The apparatus of claim 1, wherein the at least one processor is further configured to cause the print error diagnosis manager at least to:
receive notifications from the print diagnosis devices in the test set; and
pause or cancel the diagnostic test when a notification indicates a security breach.

17. The apparatus of claim 1, wherein the at least one processor is further configured to cause the print error diagnosis manager at least to:
detect a presence of a person in an operating space of at least one of the print diagnosis devices in the test set based on image data received from an imaging device monitoring the operating space;
analyze the image data to detect one or more characteristics of the person;
determine whether the person is permitted to be in the operating space; and
prevent exposure to the print job via the at least one of the print diagnosis devices when the person is not permitted to be in the operating space.

18. The apparatus of claim 1, further comprising the at least one on-premises print-related machine.

19. A method comprising:
receiving a print error file comprising information regarding an error in printing a print job at a print system;
determining a configuration of the print system;
selecting a test set of print diagnosis devices from a pool of the print diagnosis devices to run a diagnostic test on the print error file based on the configuration of the print system, wherein the test set of the print diagnosis devices includes at least one on-premises print-related machine;
constructing a private local network comprised of the test set of the print diagnosis devices;
instructing the test set of the print diagnosis devices in the private local network to perform the diagnostic test on the print job;
receiving diagnostic test results from performing the diagnostic test; and
analyzing the diagnostic test results by performing a comparison of elements of the diagnostic test results to corresponding elements of the print error file to identify differences.

20. A non-transitory computer readable medium embodying programmed instructions executed by a processor, wherein the instructions direct the processor to implement a method comprising:
receiving a print error file comprising information regarding an error in printing a print job at a print system;
determining a configuration of the print system;
selecting a test set of print diagnosis devices from a pool of the print diagnosis devices to run a diagnostic test on the print error file based on the configuration of the print system, wherein the test set of the print diagnosis devices includes at least one on-premises print-related machine;
constructing a private local network comprised of the test set of the print diagnosis devices;
instructing the test set of the print diagnosis devices in the private local network to perform the diagnostic test on the print job;
receiving diagnostic test results from performing the diagnostic test; and
analyzing the diagnostic test results by performing a comparison of elements of the diagnostic test results to corresponding elements of the print error file to identify differences.
